(19) United States
(12) Patent Application Publication
(10) Pub. No.: US 2013/0021476 A1
(43) Pub. Date: Jan. 24, 2013

(54) CHILD SEAT SAFETY SYSTEM

(71) Applicant: Marcus A. Trummer, Las Vegas, NV (US)

(72) Inventor: Marcus A. Trummer, Las Vegas, NV (US)

(21) Appl. No.: 13/629,110

(22) Filed: Sep. 27, 2012

Related U.S. Application Data
(63) Continuation-in-part of application No. 13/486,207, filed on Jun. 1, 2012.
Application No. 13/486,207 is a continuation of application No. 12/561,509, filed on Sep. 17, 2009, now Pat. No. 8,217,796.
(60) Provisional application No. 61/104,673, filed on Oct. 10, 2008.

(51) Int. Cl. H04N 7/18; B60Q 1/00

(52) U.S. Cl. 348/148; 340/438; 348/E07.085

(57) ABSTRACT

A Child Seat Safety System for providing monitoring of an interior area of a vehicle is described herein. The monitoring system includes a plurality of sensor modules that are adapted to be mounted within the vehicle for monitoring a plurality of vehicle operating parameters, and a monitoring device that is coupled in communication with the plurality of sensor modules. The monitoring device transmits signals indicative of the associated sensed operating parameter to a user communication device, and receives, from the user communication device, signals indicative of a user selection input associated with one or more sensor modules of the plurality of sensor modules. The monitoring device also selectively activates one or more sensor modules of the plurality of sensor modules based on the received user selection to operate the monitoring system to facilitate monitoring the vehicle interior.

### CROSS-REFERENCE TO RELATED APPLICATIONS

This application is a continuation-in-part of U.S. patent application Ser. No. 13/486,207, filed on Jun. 1, 2012, which is a continuation of U.S. patent application Ser. No. 12/561,509, filed on Sep. 17, 2009, now U.S. Pat. No. 8,217,796, which issued on Jul. 10, 2012, which claims priority to U.S. Provisional Patent Application Ser. No. 61/104,673, filed Oct. 10, 2008, the entire disclosure of which are hereby incorporated by reference.

### FIELD OF THE INVENTION

Motor Vehicle Passenger Safety Devices.

### BACKGROUND OF INVENTION

The safety for babies and small children (children) within vehicles has been the center of various debates for auto manufactures, consumer and government safety groups, along with respective parents or guardians. At the heart of these debates is the prime directive of providing the safest possible environment for children while being transported or inside motor vehicles.

The US Department of Transportations issued new regulations for such on Sep. 18, 2006, which require children under three years of age to use a child restraint and that drivers are legally responsible for making sure that children under 14 years use seat belts. Supplementing federal standards, all states have codified variations for safety belt enforcement (primary/secondary), fines for such, child restraint requirements, fines for such, ages for such, exempted vehicles and other.

It should be noted that to meet these requirements, many child seat products have been developed and that child seat technology has drastically improved over the last few decades. One significant innovation and government requiring the use of the Lower Anchors and Tethers for Children (LATCH) system. Assisting in a different way, another important program, WHALE, “We have a little emergency—Child Safety Seat Occupant Identification Program”' assists drivers with child care after an accident has occurred.

However, with such and a host of other advances, the National Highway Traffic Safety Administration (NHTSA) has recently launched (Mar. 2, 2009) a Statement of Review of Federal Standards for Child Safety Seats and has stated, “though current standards are exceedingly thorough, the agency is always looking at ways to make highway travel even safer for children.”

The number one reason according to NHTSA is that “every year, thousands of young children are killed or injured in crashes, mainly because 3 out of every 4 children in child safety seats are not properly secured, or even worse, not restrained at all.”

Aside from direct child seat safety technology and related advances, hindering the attention to children in vehicles is the other societal advances in technology within and not part of the vehicle with regards to navigation (GPS), communication (hands free, cell phones, PDA's, smartphones, tablets), entertainment (TV's, I-pods, Games, radio, internet, tablets), and other factors such as marketing along our nations highways and roads and general population increases which impede the focus of respective drivers. Accordingly, the monitoring of Children within a vehicle has gone from a prime parental concern to a part of larger social order harboring so many distractions which has lead to either serious injury and deaths of children through driver mistake and negligence. Quoting the American Academy of Pediatrics. “Never leave your child alone in or around cars. Any of the following can happen when a child is left alone in or around a vehicle: Temperatures can reach deadly levels' in minutes, and the child can die of heat stroke. They can be strangled by power windows, sunroofs, or accessories. They can knock the vehicle into gear, setting it into motion or be backed over when the vehicle backs up.”

Pursuant to such, there is a clear need for the present invention, i.e., the Child Seat Safety System (CSSS system), which continues the societal development of ways to improve the safety of our children. Currently, there is no real time monitoring system for the connectivity and environment monitoring surrounding children in child seats. Continuing there is no automated notification to the driver or the vehicle owner of issues with connectively or rises in temperature. Lastly, in the case when the driver is not available (left child in car) or is incapacitated from a an accident, existing technologies do not initiate an alarm sequence to notify either near-by third parties, identification of a child in car for emergency personnel, or notification to the driver and others indicating a dangerous situation. We believe the CSSS addresses such issues and should be considered for use on all vehicles equipped to install child seats.

Accordingly, there is a need to provide a vehicle monitoring system that enables a parent to view and determine the comfort and status of a child while maintaining a primary focus on driving and a system that does not require the parent to stop the car and move to the vehicle backseat to check on the status of the child.

### BRIEF SUMMARY OF THE INVENTION

The Child Seat Safety System provides drivers and other vehicle occupants with an alarm and monitoring system for the attachment of safety harnesses for respective child seat occupants within the car and for detailing changes in temperatures in the child seat immediate environment to enable the driver to monitor the vehicle occupants without being distracted from driving. The monitoring components are programmable for various alarm features and the device than provides on-going details relating to the attached “status” of said harnesses and temperatures through indicator lights on the main operator dashboard along with on the system device. Other alarm features automatically warn the driver, surrounding bystanders, or emergency personnel of alarm situations which include significant temperature variances, harness disengagement, accident or unattended occupant warnings.

In one embodiment, a monitoring system for providing monitoring of an interior of a vehicle is provided. The monitoring system includes a plurality of sensor modules that are adapted to be mounted within the vehicle for monitoring a plurality of vehicle operating parameters, and a monitoring device that is coupled in communication with the plurality of sensor modules. The monitoring device receives signals from the sensor modules that are indicative of the sensed operating parameters and monitors the vehicle interior based on the sensed operating parameters. The monitoring device transmits one or more monitoring signals indicative of the associated sensed operating parameter to a user communication device, and receives, from the user communication device, signals indicative of a user selection input associated with one or more sensors of the plurality of sensor modules. The monitoring device also selectively activates one or more sensor modules of the plurality of sensor modules based on the received user selection to operate the monitoring system to facilitate monitoring the vehicle interior.

In another embodiment, one or more computer-readable storage media having computer executable instructions thereon is provided. The computer-executable instructions cause the at least one processor to receive, a plurality of one sensor module mounted within a vehicle, a plurality of signals indicative of a plurality of vehicle operating parameters for monitoring one or more vehicle interior zones, and selectively activate one or more sensor modules of the plurality of sensor modules in response to a user selection. The computer-executable instructions also cause the processor to determine a status of the vehicle interior zone based on the sensed vehicle operating parameters received from the activated sensor modules, and graphically present a notification indicative of the determined status of vehicle interior area on a user communication device to facilitate monitoring the vehicle interior zone while driving.

### BRIEF SUMMARY OF THE SEVERAL VIEWS OF THE DRAWING

The attached figures consist of the following, and make reference to, the detailed description outlined below:

FIG. 1 is a cross-section of the CSSS component parts which are the CSSS Seat Module, the CSSS CPU Module or connection control and monitoring system (center) and alarm indicators via the Communication Outputs (out) to the vehicles dashboard, the child seat, and remote communication devices.

FIG. 2 is a frontal view of the CSSS CPU Module and details the various inputs received from the vehicle monitoring devices, power sources and feedback from the CSSS Seat Module. Furthermore, it details the areas controlling the local and remote alarm systems.

FIG. 3 is a frontal view of the CSSS Seat Module. This figure demonstrates how an existing child seat harness would be inserted into the vehicle equipped component harness clip. This figure further depicts some of the Seat Belt Module monitoring and alarm components.

FIG. 4 depicts the methods of CSSS Output Alarms. CSSS CPU Module System programming coordinates the notification of certain alarms to the vehicles monitoring systems and external alarms along with the CSSS Seat Module.

FIG. 5 is a block diagram of the CSSS system shown in FIG. 1, according to an embodiment of the present invention.

FIG. 6 is a front view of a portion of the CSSS system shown in FIG. 1, according to an embodiment of the present invention.

FIG. 7 is a partial perspective view of the CSSS system shown in FIG. 1 mounted within a vehicle, according to an embodiment of the present invention.

FIG. 8 is a top-section view of a vehicle including the CSSS system shown in FIG. 1, according to an embodiment of the present invention.

FIG. 9 is a graphical display of a monitoring interface that may be used with the CSSS system shown in FIG. 1, according to an embodiment of the present invention.

FIG. 10 is a graphical display of a configuration interface that may be used with the CSSS system shown in FIG. 1, according to an embodiment of the present invention.

### DETAILED DESCRIPTION OF THE INVENTION

Complimenting the engineering technologies for seat belts, child seats, and Lower Anchors and Tethers for Children (LATCH) system (LATCH), the Child Safety Seat System (CSSS) assists drivers in a different manner by providing real time monitoring of the occupants status. The CSSS Module (1) would be housed near or around the rear seats of a vehicle. The device is a self contained monitoring and communication system designed to be connected to the vehicles power source via a Power Source Input (8), engine indicators such as an Ignition Sensor (7), safety/accident systems including airbag inflation via a Safety System Input (9), and the physical components for the vehicles Seat Module (2). The CSSS CPU Module CPU System (19) also contains a communication system that is linked to its own warning lights and alarms in the form of Communication Outputs (6) along with the separate connections to the vehicles in-car Dash Board Alarm Output (13), the vehicles horn/alarm system output (14) (horn), and can be configured to communicated with other external communication devices, as programmed. Further explanation of operation through related figures:

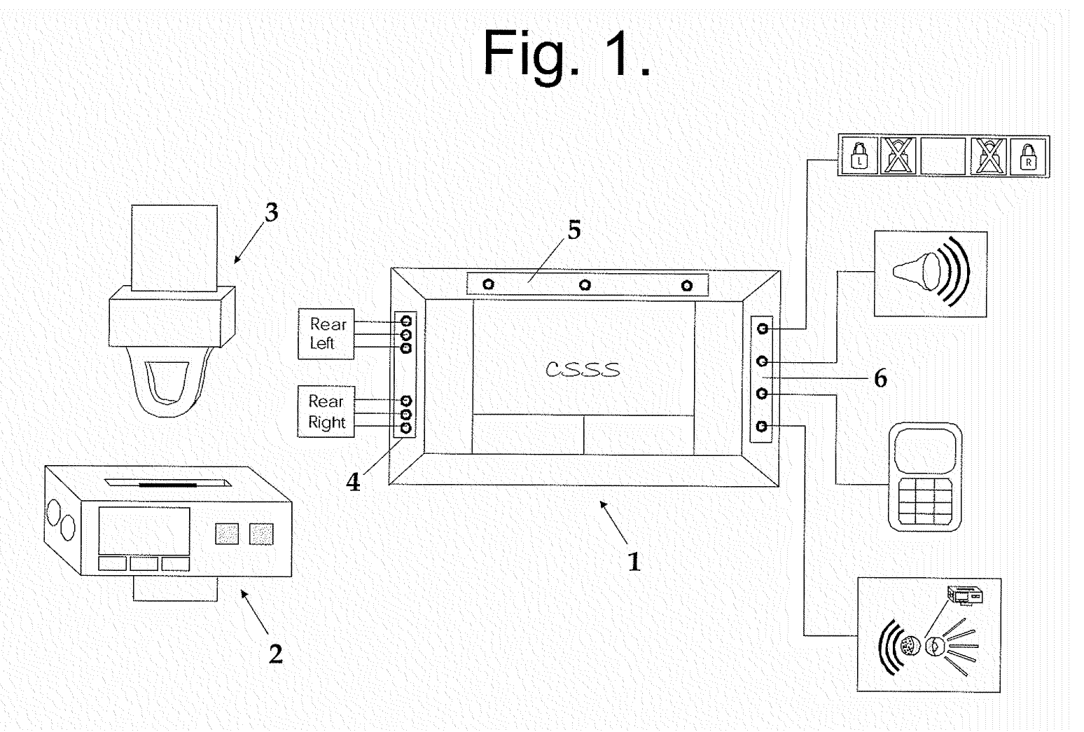

FIG. 1 is a cross-section of the three primary CSSS component parts. Specifically, the first component is the CSSS Seat Module (2) which connects to a common vehicles seat belt system for both the left and right rear seats of the vehicle. The Seat Module (2) is attached to the existing child seat harnesses (3). Continuing, the next component is the CSSS Module (1), or connection control and monitoring system. The CSSS Module (1) is built into the framework of the vehicles back seat and would be positioned below the area accommodating child seats. The CSSS Module (1) processes the continuous data streaming from the CSSS Seat Module (2) through the Seat Belt Inputs (4), and various information streams from the Vehicle Inputs (5). In processing such, the CSSS Module (1) will assess such information against user programming to determine whether an alarm signal should generated and sent to specific Communication Outputs (6). These Communication Outputs (6) are components that are integrated into the either the vehicles dashboard or; as part of the CSSS Seat Module (2); or connected to the vehicles horn/alarm system; or lastly can be linked to other common communication devices such as PC's or cell phones.

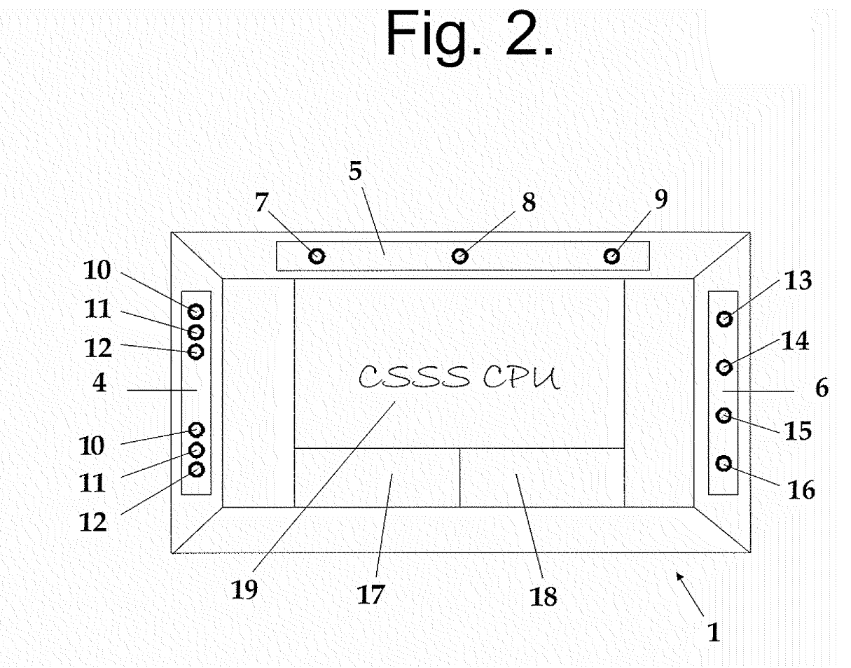

FIG. 2 is a frontal view of the CSSS Module (1). This view details first on the left side the inputs received from both the left and right rear (if two CSSS's systems are used) CSSS Seat Modules (2). Specifically, the Seat Belt Inputs (4) include the devices Seat Module Temperature Input (10) that provides real time temperature readings for the area the Seat Module is located in, the Seat Module Connectivity Input (11) which provides ongoing signals detailing whether the seat belt for the Seat Module (2) is engaged, and the Seat Module Set-up Input (12) which provides the specific user parameters set up by the vehicle driver.

The top portion of the CSSS Module (1) details the Vehicle Inputs (5) which include the Ignition Sensor Input (7) a on-going connection from the vehicles ignition monitoring system (car on/off) to understand the vehicles operational status, the Power Source Input (8) a connection from the vehicles battery for general power use, and a Safety Sensor Input (9) connecting to the vehicles safety systems (airbag/accident notification) which would communicate any emergency situation.

The indicators located below the CSSS Module (1) detail some the internal components with the module. Specifically, the CSSS Module CPU System (19) is the electrical component that receives all the inputs indicated and processes the information to determine, based on users settings, which alarm communications should be made, if any. Two other components that have housing doors are the Battery Housing (18) for running the CSSS system when the vehicles hard coded power supply fails and also the Timer Component (17) which feeds common time clock and time counts to the CSSS Module CPU (19).

Lastly, on the right side of the CSSS Module (1) the Communication Outputs (6) area includes four specific output leads designated for the CSSS Module CPU (19) communication systems. Specifically, the leads relate to the signal outputs for the vehicles Dash Board Alarm Output (13) which provides real time communications to the drivers heads up dash display, the Vehicle Horn Alarm Output (14) which provides signals for the use of the vehicles horn, the Device (and related) Alarm Output which provides signals to an external communication system (cell phone, smartphone), and Seat Module Alarm Output which sends signals through a hard line back to the CSSS Seat Module (2) alarm features.

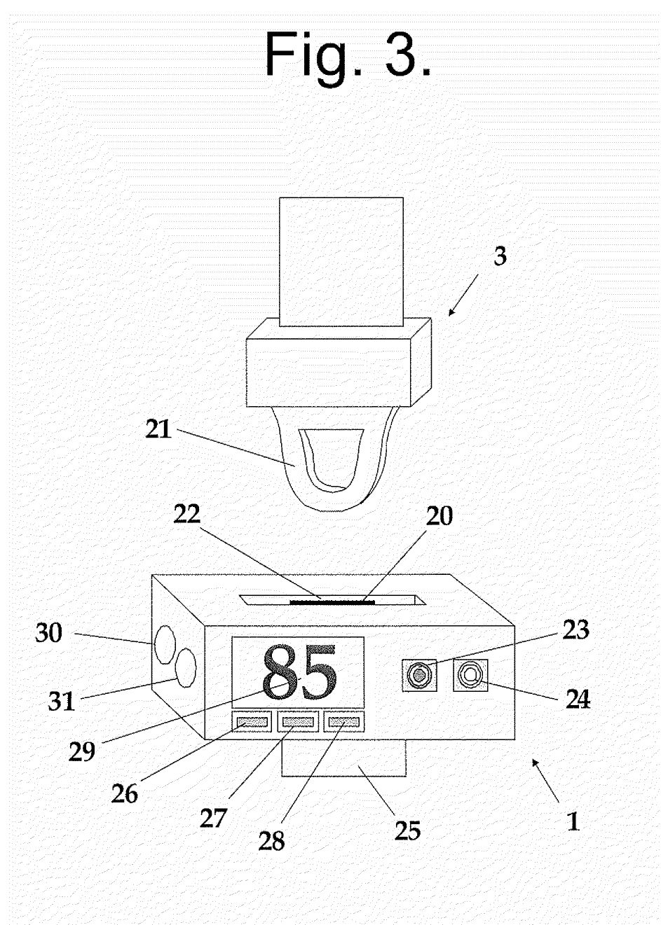

FIG. 3 is a frontal view of the CSSS Seat Module (2) component. This figure demonstrates how an existing child seat belt (3) with a common Seat Belt Clamp (20) would be inserted into the CSSS Seat Module (2) equipped with a Connection Clip (21). To ensure the safety of an occupant the first assurance of such is the continued use of vehicles safety belts while within the vehicle. CSSS monitors the connectivity of such via a Connection Sensor (22) located within the CSSS Seat Module (2) and notifies the driver immediately when the safety belt is disengaged for any purpose. Notification is immediately made at the CSSS Seat Module (2) via a Seat Module Visual Alarm Component (31) and Seat Module Sound Alarm Component (30) and the connection status changes from “system OK” to “alarm” which also sends a single to the CSSS Module CPU System for further alarm considerations. Separately, a child's safety can be impacted with extreme shifts in vehicle temperature. The CSSS Seat Module (2) provides the driver with a real time monitoring for the temperature at the seat location via Seat Module Temperature Screen (29). The driver can use the program keys, detailed as Seat Module Set-up (27), Increase (26), and Decrease (28) buttons, respectively, to set the desired temperature ranges that are acceptable, or select from pre-set and approved industry/geographical standards. A common LCD readout of such selections will display on the Seat Module Temperature Screen (29). The operational status of the CSSS Seat Module (2) is detailed via the Power On/Off

Indicator (23) and the CSSS System Error Indicator Light (24).

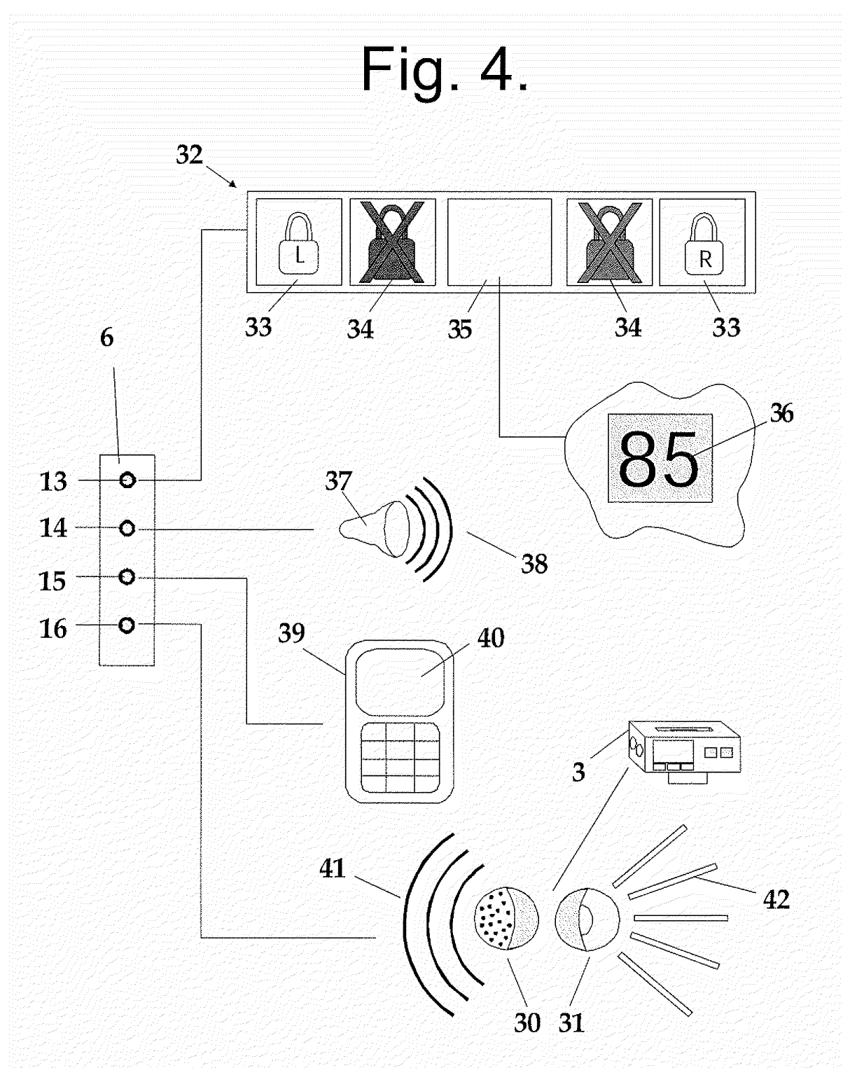

FIG. 4 depicts the methods of communicating CSSS alarms. The CSSS Module CPU programming coordinates the notification of certain alarms by initiating signals through the modules Communication Outputs (6). When certain parameters are met, the following alarm outputs would be initialed: Dash Board Alarm Output (13), Vehicle Horn Alarm Output (14), Device Alarm Output (15), and the Seat Module Alarm Output (16). The following types of driver/bystander communications are available:

Communicating (Alarm) for seat temperature outside of programmed parameters during vehicle operation (motor on and moving). The vehicles owner will program the CSSS Module CPU to acceptable levels of the interior temperature surrounding the respective child seat via the CSSS Seat Module controls as indicated in FIG. 3. When the temperature of the interior either exceeds or falls below such parameters the alarm sequence is initiated, as follows:

The primary indication of such will be through the Dash Monitoring Panel (32) in which the indicator lights for the Seat Module Temperature (OK) Indicator Light (35) along with the Seat Module Temperature (NOT OK) Indicator Light (36) would indicate through illumination the seat temperature on an on-going basis.

In addition, notification is also made at the CSSS Seat Module (2) Alarm Components (30,31) in the form of flashing lights or a Seat Module Visual Alarm (42) and through sound via the Seat Module Sound Alarm (41) in which the temperature alarm would be indicated.

Communicating (Alarm) for disengaged seat belts during vehicle operation (motor on and moving). An alarm at the seat notifies the vehicles occupants that the seat belt system has been disengaged. This assists the drivers monitoring of the occupant but also trains other occupants and the child seat occupant the importance of the continued connectivity via visual and oral alarms. The associated alarm sequence is as follows:

The primary indication of such will be through the Dash Monitoring Panel (32) in which the indicator lights for the Seat Module Secure Indicator Light (33), indicated for both left and right seats, respectively, along with the Seat Module Not Secure Indicator Light (34) would indicate through illumination the connection status on an on-going basis.

In addition, notification is also made at the CSSS Seat Module (2) Alarm Components (30, 31) in the form of flashing lights or a Seat Module Visual Alarm (42) and through sound via the Seat Module Sound Alarm (41).

Communicating (Alarm) for unattended occupants to surrounding area of car and to specific driver device(s) when vehicle is not in operation (off) or in operation (on but idle for a certain period of time). CSSS monitors when the vehicle has either stayed idle for a specific period of time or has been turn-off for a specific period of time and the SCCC Seat Module remains engaged. When a set time standard has been passed, CSSS will trigger an alarm sequence, as follows:

Initially, CSSS will use the Vehicle Horn (37) to initiate the Vehicle Sound Alarm (38) so that either the driver or other third parties that the Child Seat has an occupant.

Initial notification is also made at the CSSS Seat Module (2) Alarm Components (30, 31) in the form of flashing lights or a Seat Module Visual Alarm (42) and through sound via the Seat Module Sound Alarm (41).

Secondarily, CSSS, after a specific initial alarm period will sends text, email and calls via a Device Alarm (40) to owner configured third party communication Device (39) to ensure that the of occupant is removed from the vehicle as soon as possible. Such mobile device notification could also be configured to include a 911 call.

Communicating (Alarm) to direct the attention of emergency personnel or other third parties that an unattended occupant is in the car. If the vehicle is party to an accident and the driver and/or other occupants and incapacitated or can not assist in the removal of a child seats occupants, the following alarm sequence will be triggered to assist emergency personnel in identifying that such an occupant exits upon arrival to the accident location:

Initial notification is made at the CSSS Seat Module (2) Alarm Components (30, 31) in the form of flashing lights or a Seat Module Visual Alarm (42) and through sound via the Seat Module Sound Alarm (41).

Secondarily, CSSS, after a specific initial alarm period will sends text, email and calls via a Device Alarm (40) to owner configured third party communication Device (39) to ensure that the of occupant is removed from the vehicle as soon as possible. Such mobile device notification could also be configured to include a 911 call.

Thus is can be seen, how the aforementioned claims address the need for CSSS Module System by improving the safety of child seats. As described, CSSS will provide for the real time monitoring of the children within vehicle child seats in both the capacities of the attached status of seat belts and the within the correct temperature controlled environment. The key is the independent monitoring allows a second layer to the primary defenses each parent should provide to their respective children. The automated function and notification allow for both internal and external alarm communication not currently realized by any existing products. This communication also has the ability to bridge vehicle safety features to the information age via cell phones, smartphones, tablets, and PDA's. The final advancement is the use of such automated communication during the case when the driver is either not available or incapacitated which provides a new opportunity for securing a child in emergency situations. Accordingly, we believe CSSS will be the next LATCH mechanism for the auto industry which will continue the social advancement of enhanced safety of travel through innovation. We will be applying to local and NHTSA administrations and US Department of Transportation for product assessment to acquire certification of such organizations.

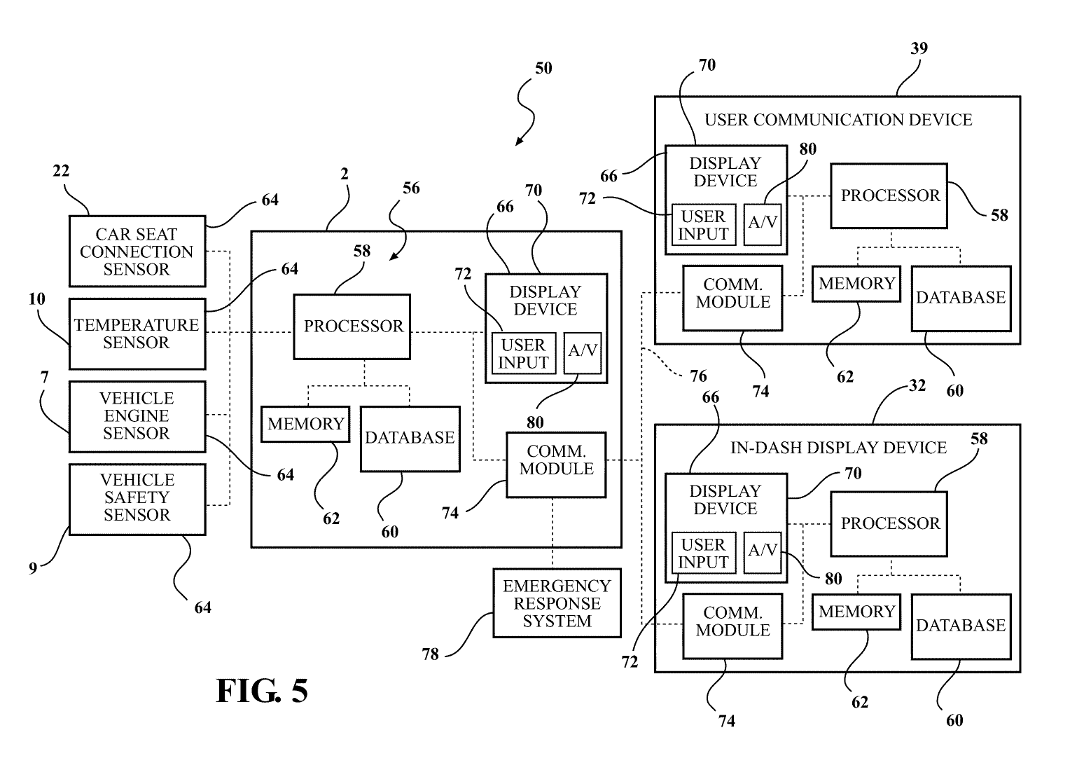

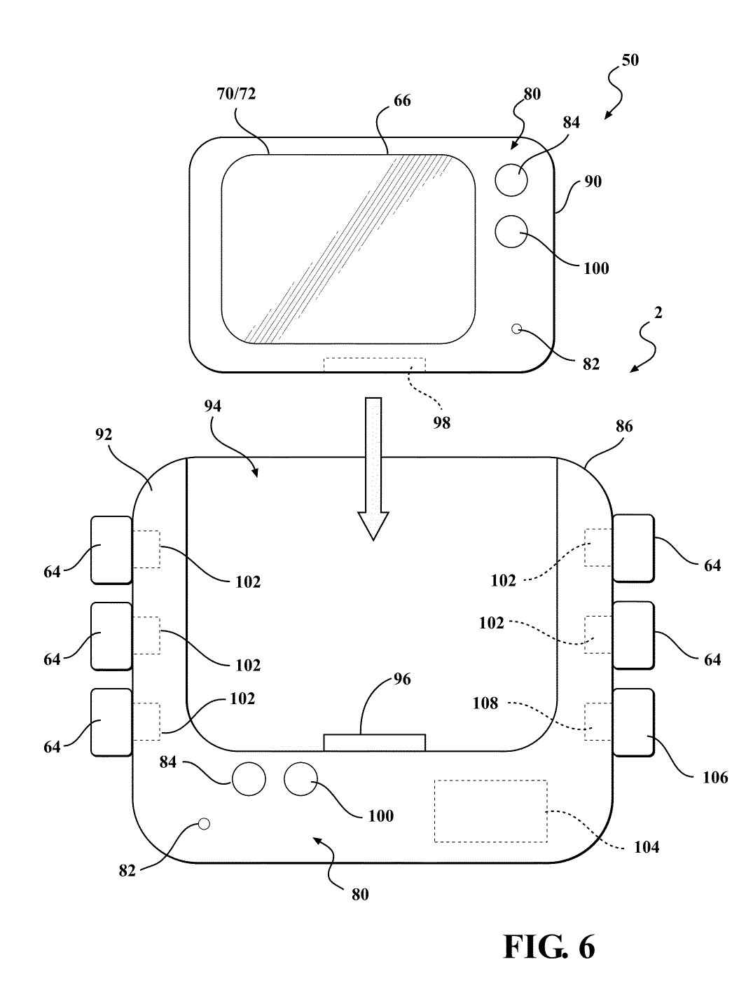

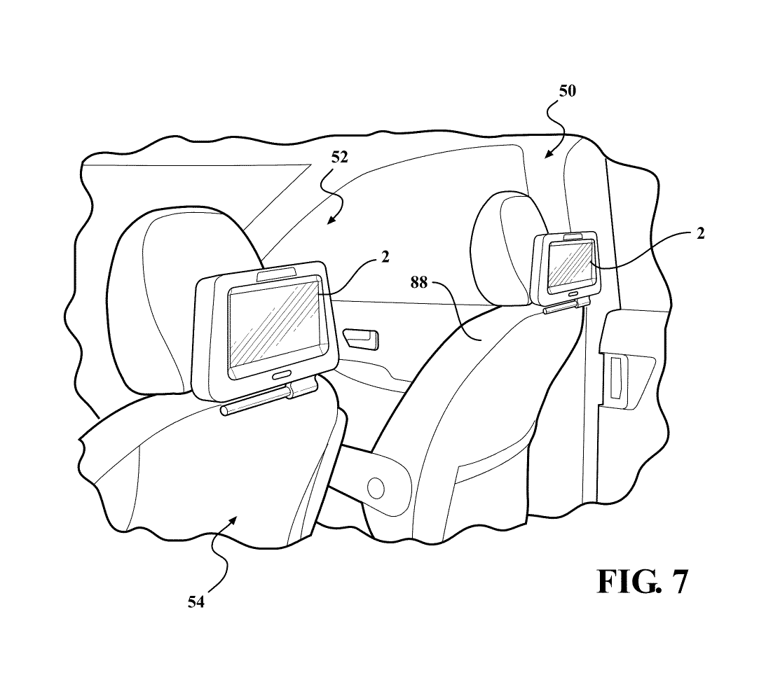

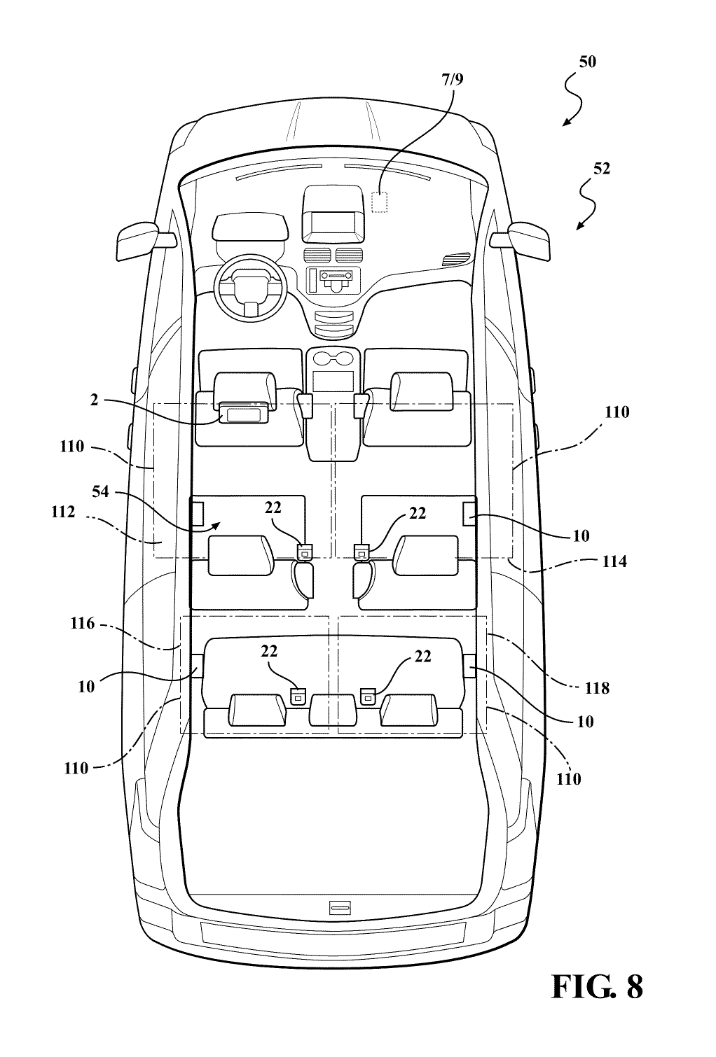

FIG. 5 is a block diagram of the CSSS system 50, according to an embodiment of the present invention. FIG. 6 is a front view of a portion of the CSSS system 50. FIG. 7 is a partial perspective view of the CSSS system 50 mounted within a vehicle 52, according to an embodiment of the present invention. FIG. 8 is a top-section view of the vehicle 52 including the CSSS system 50. In the illustrated embodiment, the CSSS system 50 is configured to enable a parent to monitor a child seat area 54 of a vehicle 52 during both day and nighttime driving and to enable safe allowable interaction with a child seated in the child seat area 54. The CSSS system 50 monitors the well-being of the child with the use of a camera, monitoring data, and/or video and audio interaction. The CSSS system 50 enables the parent to determine if the child is choking, needs water, or any general situation in which comfort or care would be warranted by providing two-way communication with the child. The CSSS system 50 also includes a lighting device to enable the parent to monitor the child both during the day and at night. In addition, the CSSS system camera allows for the recording of certain events, whether, those are for “monitoring” of certain health issues with the child or for general parent use. In addition, the CSSS system 50 enables the parent to display or play audio files or video to assist with the child's comfort or for general use in keeping the child busy during driving, and allows the parent to tailor the content continuously and monitor or change the content displayed to the child in real time. By providing a system that enables a parent to determine the comfort and status of the child at night without stopping the car and going to the back seat, the CSSS system 50 provides parents with advanced warnings of any issues with the child and enable the parents to view such status while maintaining their primary focus on driving.

In the illustrated embodiment, the CSSS system 50 includes a monitoring device, i.e., CSSS module 2 that includes a controller 56 including a processor 58 that is coupled in communication with a database 60 and a memory device 62 for executing programmed instructions. In some embodiments, executable instructions are stored in the memory device 62. Alternatively, or in addition, executable instructions may be retrieved from another device via a computer network. In the exemplary embodiment, the controller 56 is programmable to perform one or more operations described herein by programming the processor 58. For example, the processor 58 may be programmed by encoding an operation as one or more executable instructions and providing the executable instructions in memory device 62. The methods described herein may be encoded as executable instructions embodied in a non-transitory computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

In the exemplary embodiment, memory device 62 is one or more devices that enable information, such as executable instructions and/or other data, to be selectively stored and retrieved. Memory device 62 may be configured to store, without limitation, executable instructions and/or any other type of data suitable for use with the methods described herein.

In the illustrated embodiment, the processor 58 is coupled in communication with one or more sensor modules 64 such as, for example, the seat belt connection sensor 22, the temperature sensor 10, the ignition sensor 7, and the vehicle safety sensor 9, for sensing a plurality of operating parameters of vehicle 52. Each sensor module 64 is configured to sense one or more vehicle operating parameters and transmit a signal corresponding to the sensed vehicle operating parameter to the processor 58. The vehicle operating parameters include, but are not limited to, a child seat restraint system status, a vehicle interior temperature, a engine operating status, a vehicle safety status, and/or any suitable vehicle operating parameter that enable the CSSS system 50 to function as described herein.

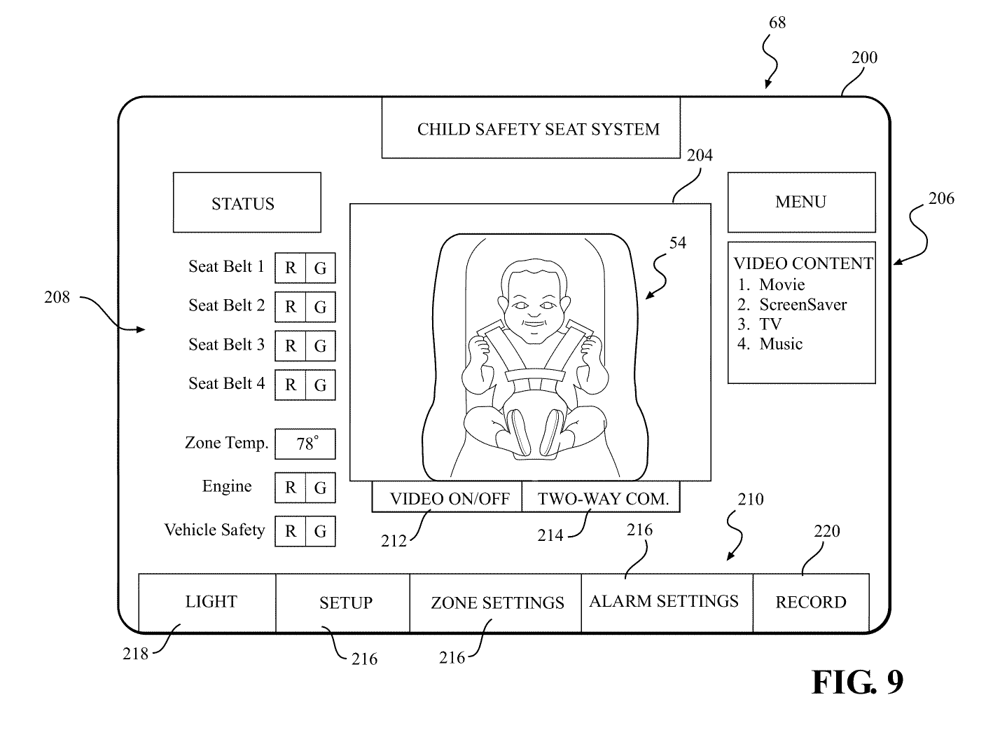

In the exemplary embodiment, the monitoring device 2 includes a presentation interface device 66 that is coupled to processor 58. The presentation interface device 66 is configured to output display information such as, but not limited to, a graphic display 68 (shown in FIG. 9) including a plurality of graphical images corresponding to the sensed operating parameters of vehicle 52. For example, presentation interface device 66 may include a display adapter (not shown) that is coupled to a display unit 70, such as a cathode ray tube (CRT), a liquid crystal display (LCD), a light-emitting diode (LED) display, and/or an organic LED (OLED) display. In some embodiments, presentation interface device 66 includes more than one display units 70. Presentation interface device 66 may also include one or more audio speakers (not shown).

In the illustrated embodiment, the presentation interface device 66 also includes an input interface 72 that receives input from user. Input interface 72 may be configured to receive a selection or entry of configuration data (e.g., a sensor configuration, a monitoring zone setting, and an alarm setting), and/or any other information suitable for use with the methods and systems described herein. In the exemplary embodiment, input interface 72 is coupled to the processor 58 and may include, for example, a keyboard, a pointing device, a mouse, a stylus, a touch sensitive panel (e.g., a touch pad or a touch screen), a touchless panel, a gyroscope, an accelerometer, a position detector, a toggle switch, a selector dial, and/or an audio input interface. A single component, such as a touch screen, may function as both a display unit 70 of presentation interface device 66 and as input interface 72 to enable processor 58 to receive a user selection input via the graphic display 68.

The monitoring device 2 also includes a communication module 74 that is coupled to the processor 58 for communication with one or more remote devices such as, for example, a user communications device, i.e., device 39, and/or an in-dash display device, i.e., dash monitoring panel 32 via a network 76. The communication module 74 may include, without limitation, a wired network adapter, a wireless network adapter, and/or a mobile telecommunications adapter. The communications module 74 remotely communicates data signals to and from sensor modules 64, monitoring device 2, user communications device 39, and/or in-dash display 32 with any wired communication protocol, i.e., universal serial bus (USB) and/or wireless communication protocol, i.e., Bluetooth® known to one of ordinary skill in the art guided by the teachings herein. In one embodiment, the user communications device 39 may also include a mobile cellular phone, a smartphone, a laptop, a tablet, and/or any suitable mobile computing device. Moreover, the in-dash display device 32 may include an integrally mounted vehicle dashboard device, a display device mounted on an exterior of a vehicle dashboard, a floor mounted vehicle display, a ceiling mounted vehicle display, and/or any displace device adapted to be mounted within the vehicle. In the illustrated embodiment, the monitoring device 2, the user communications device 39, and the in-dash display device 32 each include a processor 58, a memory device 62, a database 60, a communication module 74, and/or a presentation device 66.

In the illustrated embodiment, the monitoring device 2 is also coupled in communication with an emergency response system 78, i.e., a 911 emergency response system. The communication module 74 is configured to transmit signals indicative of an alarm condition to the emergency response system 78.

The network 76 may include, without limitation, the Internet, a local area network (LAN), a wide area network (WAN), a wireless LAN (WLAN), a mesh network, a virtual private network (VPN) using a wired network connection (e.g., Ethernet or an optical fiber), a wireless communication means, such as radio frequency, a cellular phone technology, a satellite communication link, and/or any other suitable wired and/or wireless communication means.

In the illustrated embodiment, the presentation interface device 66 also includes an audio/video recording device 80 for recording audio and/or video images. In one embodiment, audio/video recording device 80 includes a microphone 82 (shown in FIG. 6) for recording audio and a video camera 84 (shown in FIG. 6) for recording visual images. In one embodiment, the processor 58 is configured to operate the audio/video recording device 80 to record audio and/or video images and store the recorded audio/video images for playback on display unit 70.

In the illustrated embodiment, the database 60 includes an entertainment program that includes a collection of audio/video entertainment content for display on presentation interface device 66. In one embodiment, the collection of entertainment content includes movies, recorded television shows, music, video games, digital pictures, and/or any suitable audio/video content for display via presentation interface. The processor 58 is configured to enable a user to access and select entertainment content from the entertainment program via the user input interface 72 for display on the display unit 70.

Referring to FIG. 6, in the illustrated embodiment, the monitoring device 2 includes a housing 86 that is adapted to be mounted to a vehicle seat 88 (shown in FIG. 7), and a computing device 90 that is removably coupled to the housing 86. In one embodiment, the housing 86 is removably coupled to the vehicle seat 88 with a mounting bracket, a strap, and/or any suitable fastening assembly. Alternatively, the housing 86 may be embedded in a vehicle seat headrest, or securely fastened to the vehicle seat 88.

In the illustrated embodiment, the housing 86 includes an outer surface 92 that defines a groove 94 that is sized to receive the computing device 90 therein to secure the computing device 90 to the housing 86. In one embodiment, the housing 86 includes a docking module 96 that is sized to be received within a corresponding docking port 98 to enable the housing 86 to be coupled in communication with the computing device 90. The computing device 90 is configured to communicate with the housing 86, the user communications device 39, and/or the in-dash display device 32 via the network 76, when the computing device 90 is connected to the housing 86, and detached from the housing 86. The housing 86 includes the power source input 8 for connecting the housing to the vehicle battery for us in providing power to the housing 86 an the computing device 90.

In the illustrated embodiment, the computing device 90 includes a presentation interface device 66 including the display unit 70, the user input interface 72, and the audio/video recording device 80. The presentation interface device 66 is configured to display entertainment content such as, for example, video images, movies and/or TV shows selected by the parent to facilitate entertaining the child while driving. The presentation interface device 66 also enables the parent to record audio and/or video of the child from the computing device 90 and display the images on the user communications device 39 and/or the in-dash display device 32. Alternatively, the housing 86 may include the audio/video recording device 80.

The CSSS system 50 is configured to enable the parent to selectively activate the audio/video recording device 80 to record the child, and display the recorded images on the in-dash display device 32 and/or the user communications device 39 in real time. In addition, the CSSS system 50 enables the parent to select entertainment content from database 60 and display the selected entertainment content to the child on the presentation interface device 66. Moreover, in the illustrated embodiment, the CSSS system 50 is configured to enable the parent to initiate two-way communication with the child via the monitoring device 2 and the user communications device 39 and/or the in-dash display device 32. This allows for the direct line(s) of sight over the child within the child seat area and provides for direct monitoring of the child.

In the illustrated embodiment, the housing 86 also includes a lighting device 100 that is configured to transmit light towards the child seat area 54 to facilitate illuminating the child seat area 54 and/or a child seated in the child seat area 54. The monitoring device 2 is operatively coupled to the lighting device 100 to enable a parent to selectively operate the lighting device to illuminate the child seat area 54.

The housing 86 also includes a plurality of sensor ports 102 that are each sized and shaped to receive a corresponding sensor module 64 therein. Each sensor module 64 is removably coupled to the housing sensor port 102 such that each sensor module 64 may be removed from the housing 86 and mounted in a location within the vehicle 52. Each sensor port 102 includes a communication device (not shown) to couple a corresponding sensor module 64 in communication with the housing 86 and/or the computing device 90. In one embodiment, the housing 86 includes a back-up battery power supply 104 that provides power to the computing device 90 and/or each sensor module 64 when the computing device 90 and/or the sensor modules 64 are coupled to the housing 86.

In the illustrated embodiment, the processor 58 is configured to detect when a sensor module 64 is connected to a corresponding housing sensor port 102 and activate the sensor module 64 to sense a corresponding vehicle operating parameter when the sensor module 64 is removed from the sensor port 102. This enables a parent to selectively activate one or more sensor modules 64 to monitor a selected child seat area 54.

In one embodiment, the housing 86 includes a communications interface device 106 that is removably coupled to a corresponding communications port 108. The communications interface device 106 may include a non-transitory computer readable medium having executable instructions embodied therein that, when executed by a processor, cause the processor to perform at least a portion of the methods described herein. The communications interface device 106 is configured to connect with the user communications device 39, the in-dash display device 32, and/or the vehicle 52 to transmit the executable instructions when connected to the user communications device 39, the in-dash display device 32, and/or the vehicle 52. This enables the user to selectably synchronize the user communications device 39, the in-dash display device 32, and/or the vehicle 52 with the monitoring device 2 to enable the CSSS system 50 to function as described herein.

In reference to FIG. 8, in the illustrated embodiment, the CSSS system 50 is configured to monitor a plurality of passenger monitoring zones 110 that are defined within the vehicle 52. Each passenger monitoring zone 110 includes one or more passenger seat areas 54. For example, in one embodiment, the vehicle 52 may include four monitoring zones 110 including a left-middle passenger zone 112, a right-middle passenger zone 114, a left-rear passenger zone 116, and a right-rear passenger zone 118. In addition, the CSSS system 50 includes one or more sensor modules 64 associated with each passenger monitoring zone 110. For example, in one embodiment, each zone 110 may include a seat belt connection sensor 22 for monitoring a seat belt connection associated with the corresponding zone 110 and a temperature sensor 10 for monitoring a temperature of the corresponding zone 110.

In the illustrated embodiment, the CSSS system 50 is configured to enable a user to selectively monitor one or more passenger zones 110 by selectively activating the sensor modules 64 associated with the selected passenger zones 110. During operation, the CSSS system 50 activates the sensor module 64 associated with the selected monitoring zones 110 and transmits signals indicative of the sensed vehicle operating parameters associated with the selected zones 110 to the user communications device 39 and/or the in-dash display device 32.

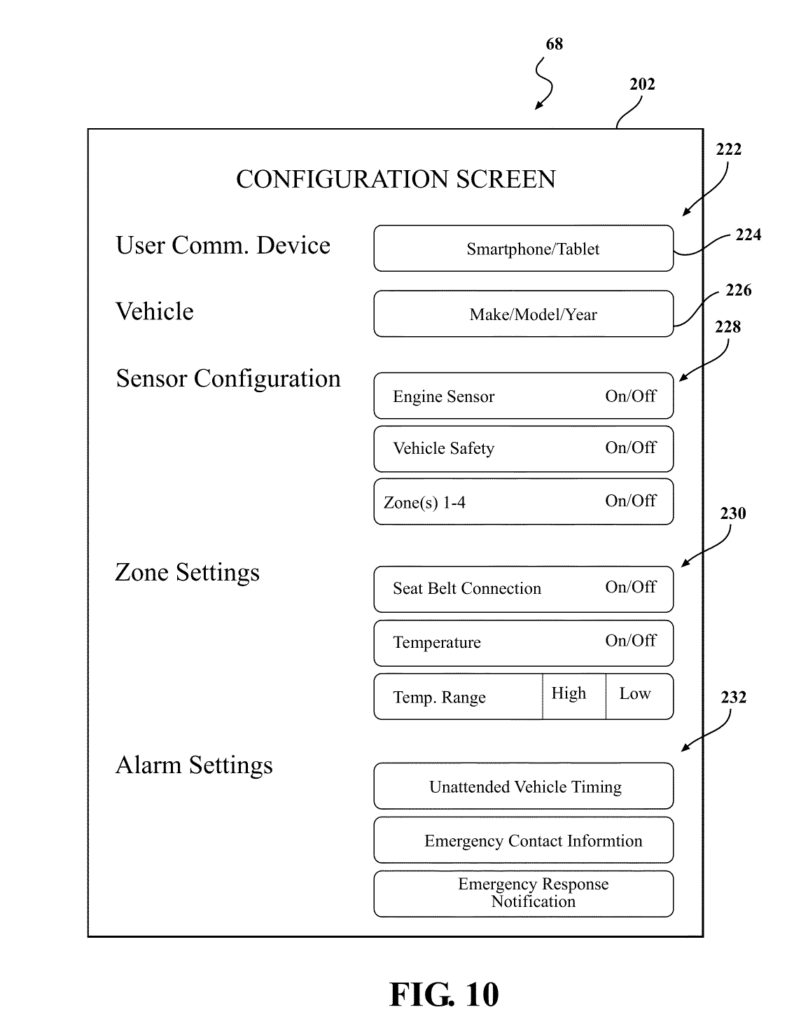

FIG. 9 is a graphical display 68 of a monitoring interface 200 that is displayed by the CSSS system 50. FIG. 10 is a graphical display 68 of a configuration interface 202 that is displayed by CSSS system 50 to enable the user to configure various operational settings used to operate the CSSS system 50. In the illustrated embodiment, the processor 58 is programmed to graphically display the monitoring interface 200 on the user communications device 39 and/or the in-dash display device 32 to enable a parent to monitor the child seat area 54. The monitoring interface 200 includes a video display area 204, an entertainment selection area 206, an operational status area 208, and a system configuration area 210.

The processor 58 is configured to receive signals indicative of a user's selection made with the monitoring interface 200. For example, if the presentation interface includes a touchpad, the user may indicate a user selection by pressing an object, such as a finger, onto an area of the monitoring interface 200 associated with the desired selection. Alternatively, if the presentation interface device 66 includes a keypad and/or a pointing device, i.e., a mouse, the user may scroll a pointer, i.e., a cursor, over the area to be selected and operate the keypad and/or mouse to select the area to indicate the user selection.

The video display area 204 is configured to display recorded images of the child seat area 54 that are received from the monitoring device 2 to enable a parent to view the child's condition via the user communications device 39 and/or the in-dash display device 32. In the illustrated embodiment, the monitoring interface 200 includes a video selector 212 that enables a user to select the video selector 212 to operate the monitoring device audio/video recording device 80 to record and transmit images for display in the video display area 204. In addition, the monitoring interface 200 includes a two-way communications selector 214 to enable a user to initiate two-way communication that includes displaying recorded images from the monitoring device 2 in the video display area 204, and transmitting recorded images from the user communications device 39 and/or the in-dash display device 32 to the monitoring device 2 for display to the child.

In the illustrated embodiment, the entertainment selection area 206 includes a menu selection of video and audio content included in the database 60 for display. More specifically, the entertainment selection area 206 enables a user to select a movie, TV show, and/or any recorded content for display to the child via the monitoring display unit 70.

The operational status area 208 displays a plurality of notification images associated with a status of a plurality of vehicle operational parameters. More specifically, the processor 58 is programmed to receive signals indicative of the vehicle operational parameters from the sensor modules 64, determine a status of the sensed vehicle operational parameters, and display a notification image associated with the determined status on the monitoring interface 200. In the illustrated embodiment, the operational status area 208 displays a first indication “R” if the sensed operational parameter is not within a predefined parameter and displays a second indication “G” if the sensed operational parameter is within the predefined parameter. Alternatively, operational status area 208 may display any suitable notification image associated with a status of a plurality of vehicle operational parameters. By displaying the status of the vehicle operational parameters, the user can quickly receive a visual indication of the status of each sensed parameter.

The system configuration area 210 includes a plurality of system configuration selectors 216 that enable a user to access a configuration interface 202 (shown in FIG. 10) to selectively configure the CSSS system 50 monitoring. The system configuration area 210 also includes a light selector 218 that enables the user to selectively activate the lighting device 100, and a record selector 220 that enables the user to selectively operate the audio/video recording device 80 to record images of the child seat area 54.

In the illustrated embodiment, the configuration interface 202 displays a plurality of system configuration selectors 222 that enable a user to selectively activate a plurality of functions of the CSSS system 50. In the illustrate embodiment, the configuration interface 202 includes a user communications device selector 224, a vehicle selector 226, a sensor configuration selector 228, a zone settings selector 230, and an alarm settings selector 232. The user communications selector 224 enables a user to identify the type of user communications device 39 to be used with the CSSS system 50, i.e., a device type, a manufacture, and/or an operating software. The vehicle selector 226 enables the user to identify the make, model, and year of the vehicle 52 to enable the CSSS system 50 to configure the ignition sensor 7 and the vehicle safety sensor 9 to communicate with the selected vehicle. The sensor configuration selector 228 enables the user to selectively activate the sensor modules 64. The zone settings selector 230 enables the user to selectively activate the sensor modules 64 associated with each passenger zone 110. The alarm settings selector 232 enables the user to configure the system alarm notifications including identifying the emergency response system 78.

In the illustrated embodiment, during operation of the CSSS system 50, the processor 58 is programmed to receive signals indicative of the sensed operating parameters from one or more sensor modules 64, and transmit the signals indicative of the associated sensed operating parameters to the user communications device 39. The processor 58 receives, from the user communications device 39, signals indicative of a user selection input associated with one or more sensors modules 64 of the plurality of sensor modules 64, and selectively activates one or more sensor modules 64 based on the received user selection to operate the monitoring system 50 to monitor at least one operating parameter. In addition, the processor 58 is programmed to receive a signal indicative of a user selection to monitor at least one vehicle passenger zone 110, and activate the sensor modules 64 associated with the selected vehicle passenger zone 110. Moreover, the processor 58 is programmed to display one or more audio/video images received from the user communications device 39 on the monitoring device 2, and to transmit signals indicative of recorded audio/video images from the monitoring device 2 to the user communications device 39 based on a user selection input. The processor 58 is also programmed to transmit a notification signal indicative of an alarm situation to the user communications device 39 based on one or more sensed operating parameter, and to display the alarm on the monitoring interface 200.

The above-described systems and methods overcome at least some disadvantages of known child monitoring systems by providing a monitoring system that allows a parent to monitor a child seat area 54 of a vehicle 52 during both day and nighttime driving, and enables safe allowable interaction with a child seated in the child seat area. The monitoring system 50 described herein includes a monitoring device 2 that is connected to a remote user communications device 39 and/or an in-dash display device 32 to enable a parent to operate the monitoring device 2 from the remote device 39 to display selected entertainment content to the child. In addition, the monitoring device 2 records and transmits images of the child to the remote user device 39 to allow the parent to safely monitor the child. By providing a system that enables a parent to determine the comfort and status of the child at night without stopping the car and going to the back seat, the CSSS system 50 provides parents with advanced warnings of any issues with the child and enable the parents to view such status while maintaining their primary focus on driving.

A controller, control system, computing device, or computer, such as described herein, includes at least one or more processors or processing units and a system memory. The controller typically also includes at least some form of computer readable media. By way of example and not limitation, computer readable media may include tangible computer storage media. Computer storage media may include volatile and nonvolatile, removable and non-removable media implemented in any method or technology that enables storage of information, such as computer readable instructions, data structures, program modules, or other data. Computer storage media typically embody computer readable instructions, data structures, program modules, or other data.

Although described in connection with an exemplary manufacturing system environment, embodiments described herein are operational with numerous other general purpose or special purpose computing system environments or configurations. The system environment is not intended to suggest any limitation as to the scope of use or functionality of any aspect of the subject matter described herein. Moreover, the system environment should not be interpreted as having any dependency or requirement relating to any one or combination of components illustrated in the exemplary operating environment. Examples of well known systems, environments, and/or configurations that may be suitable for use with the embodiments described herein include, but are not limited to, personal computers, server computers, hand-held or laptop devices, multiprocessor systems, microprocessor-based systems, set top boxes, programmable consumer electronics, mobile telephones, network PCs, minicomputers, tablets, PDAs, smartphones, distributed computing environments that include any of the above systems or devices, and the like.

The order of execution or performance of the operations in the embodiments described herein is not essential, unless otherwise specified. That is, the operations described herein may be performed in any order, unless otherwise specified, and embodiments may include additional or fewer operations than those disclosed herein. For example, it is contemplated that executing or performing a particular operation before, contemporaneously with, or after another operation is within the scope of aspects of the embodiments.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a memory device, as described herein, includes one or more computer readable media, such as, without limitation, dynamic random access memory (DRAM), static random access memory (SRAM), random access memory (RAM), flash memory, a hard disk drive, a solid state drive, a diskette, a flash drive, a compact disc, a digital video disc, and/or any suitable device that enables a processor to store, retrieve, and/or execute instructions and/or data.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enable the systems and methods to operate as described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspect and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A monitoring system of monitoring a plurality of vehicle zones of a vehicle, comprising:
a plurality of sensor modules adapted to be mounted within the vehicle for monitoring a plurality of vehicle operating parameters; and
a monitoring device coupled in communication with the plurality of sensor modules for receiving signals indicative of the sensed operating parameters, the device for transmitting one or more monitoring signals indicative of the associated sensed operating parameters to a user communication device, receiving, from the user communication device, signals indicative of a user selection input associated with one or more sensor modules of the plurality of sensor modules, and selectively activating one or more sensor modules of the plurality of sensor modules based on the received user selection to operate the monitoring system to facilitate monitoring at least one vehicle zone of the plurality of vehicle zones.

2. A system in accordance with claim 1, wherein the monitoring system includes at least one sensor module associated with each vehicle monitoring zone of the plurality of vehicle monitoring zones, the monitoring device for receiving a signal indicative of a user selection to monitor at least one vehicle monitoring zone of the plurality of vehicle monitoring zones, and activating the sensor modules associated with the selected vehicle monitoring zone.

3. A system in accordance with claim 1, wherein the monitoring device further includes a lighting device, the monitoring device for selectively operating the lighting device to illuminate at least a portion of the vehicle zone based on a user selection input received from the user communication device.

4. A system in accordance with claim 1, wherein the monitoring system further includes an audio/video recording device for recording audio/video images associated with the vehicle zone, the monitoring device for transmitting signals indicative of the recorded audio/video images to the user communication device to display the audio/video images on the user communication device.

5. A system in accordance with claim 1, wherein the monitoring system further includes a display unit for displaying audio/video images to a child seated in the vehicle zone.

6. A system in accordance with claim 5, wherein the monitoring device enables two-way communication between the monitoring system and the user communication device.

7. A system in accordance with claim 5, wherein the monitoring device selectively displays one or more audio/video images on the display unit based on a user selection input received from the user communication device.

8. A system in accordance with claim 7, wherein the user communications device includes an audio/video recording module for recording and transmitting audio/video images, the monitoring system receives signals associated with the audio/video images recorded by the user communications device and displays the recorded images on the monitoring system display unit.

9. A system in accordance with claim 1, wherein the monitoring system transmits a notification signal indicative of an alarm situation to the user communication device based on one or more sensed operating parameter.

10. A system in accordance with claim 1, wherein the user communications device includes a mobile communications device.

11. A system in accordance with claim 1, wherein the user communications device includes an in-dash display device.

12. A system in accordance with claim 1, wherein the monitoring system comprises:
a housing that is adapted to be mounted to a vehicle seat; and
a computing device removably coupled to the housing, the computing device including:
an audio/video recording device for recording audio/video images associated with the vehicle zone and transmitting the recorded images to the user communications device; and
a display unit for displaying one or more audio/video images based on a user selection input received from the user communication device.

13. A system in accordance with claim 12, wherein the housing includes a plurality of sensor ports that are each configured to receive a corresponding sensor module, the monitoring device for activating a sensor module when the sensor module is removed from the housing.

14. A system in accordance with claim 1, wherein the plurality of vehicle operating parameters includes one of a connection of a seat restraint system, a vehicle interior temperature, a engine operating status, and a vehicle safety status.

15. A system in accordance with claim 1, wherein the monitoring system presents, on the user communications device, a graphic interface that includes:
a notification area including a plurality of operational status notifications indicative of the sensed vehicle operating parameters;
a user selection area that displays a plurality of user selection inputs to enable the user to selectively activate one or more of the plurality of sensor modules; and
a video display area for displaying video images received from the audio/video recording device.

16. One or more computer-readable storage media having computer executable instructions thereon, wherein when executed by at least one processor, the computer-executable instructions cause the at least one processor to:
receive, from a plurality of sensor modules mounted within a vehicle, a plurality of signals indicative of a plurality of vehicle operating parameters for monitoring at least one vehicle zone of a plurality of vehicle zones within the vehicle;
selectively activate one or more sensor modules of the plurality of sensor modules in response to a user selection;
determine a status of the at least one vehicle zone based on the sensed operating parameters received from the activated sensor modules; and
graphically present a notification indicative of the determined status of the vehicle zone on a user communication device to facilitate monitoring the vehicle zone.

17. The one or more computer-readable storage media according to claim 16, wherein when executed by at least one processor, the computer-executable instructions cause the at least one processor to:
receive a user selection to monitor at least one vehicle zone of a plurality of vehicle zones; and
selectively activate the sensor modules associated with the selected vehicle zone.

18. The one or more computer-readable storage media according to claim 16, wherein when executed by at least one processor, the computer-executable instructions cause the at least one processor to selectively operate a lighting device to illuminate at least a portion of the vehicle zone based on a user selection.

19. The one or more computer-readable storage media according to claim 16, wherein when executed by at least one processor, the computer-executable instructions cause the at least one processor to:
operate an audio/video recording device to record audio/video images associated with the vehicle zone based on a user selection; and
display the recorded audio/video images on the user communication device.

20. The one or more computer-readable storage media according to claim 16, wherein when executed by at least one processor, the computer-executable instructions cause the at least one processor to:
receive a signal indicative of a user selection to display a user selected audio/video image on a monitoring system including a display unit; and
display the selected audio/video image display on the monitoring system display unit based on the user selection such that the selected audio/video image is viewable by a child positioned within the vehicle zone.

21. The one or more computer-readable storage media according to claim 20, wherein when executed by at least one processor, the computer-executable instructions cause the at least one processor to initiate two-way communication between the user communication device and the monitoring system display unit based on a user selection.

22. The one or more computer-readable storage media according to claim 20, wherein when executed by at least one processor, the computer-executable instructions cause the at least one processor to:
operate an audio/video module associated with the user communications device to record audio/video images and transmit the recorded audio/video images to the monitoring system based on a user selection; and
display the recorded audio/video images received from the user communications device on the monitoring system display unit.

23. The one or more computer-readable storage media according to claim 16, wherein when executed by at least one processor, the computer-executable instructions cause the at least one processor to transmit a notification signal indicative of an alarm situation to the user communication device based on one or more sensed operating parameters.

24. The one or more computer-readable storage media according to claim 16, wherein when executed by at least one processor, the computer-executable instructions cause the at least one processor to transmit a notification signal indicative of an alarm situation to an emergency response system based on one or more sensed operating parameters.

25. The one or more computer-readable storage media according to claim 16, wherein when executed by at least one processor, the computer-executable instructions cause the at least one processor to:
determine if a sensing module has been removed from a housing of a monitoring system; and
activate the sensor module to transmit signals indicative of an operating parameters if the sensor module is removed from the monitoring system housing.

26. The one or more computer-readable storage media according to claim 16, wherein when executed by at least one processor, the computer-executable instructions cause the at least one processor to determine a status of the vehicle zone based on at least one of a connection of a seat restraint system, a vehicle interior temperature, a engine operating status, and a vehicle safety status.

27. The one or more computer-readable storage media according to claim 16, wherein when executed by at least one processor, the computer-executable instructions cause the at least one processor to graphically display, on the user communications device, a graphic interface that includes:
a notification area including a plurality of operational status notifications indicative of the sensed operating parameters on the user communications device;
a user selection area that displays a plurality of user selection inputs to enable the user to selectively activate one or more of the plurality of sensor modules; and
a video display area for displaying video images received from the audio/video recording device.
